(19) United States
(12) Patent Application Publication
(10) Pub. No.: US 2009/0073516 A1
(43) Pub. Date: Mar. 19, 2009

(54) IMAGE FORMING APPARATUS

(75) Inventor: Hiromasa Tanaka, Izunokuni-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/207,770

(22) Filed: Sep. 10, 2008

Related U.S. Application Data
(60) Provisional application No. 60/972,480, filed on Sep. 14, 2007.

(51) Int. Cl. H04N 1/46

(52) U.S. Cl. 358/505

(57) ABSTRACT

A scanner reads an image of a document, the image of the document read by the scanner is stored in a memory, and a color determining section determines whether the document read by the scanner is color or monochrome. When the color determining section determines that the image of the document is color, image data stored in the memory is converted into color image data configured by multi-valued pixels by a multi-value processing section. On the other hand, when the color determining section determines that the image of the document is monochrome, the image data stored in the memory is converted into monochrome image data configured by binary pixels by a binary value processing section. A printer forms the image data processed by one between the multi-value processing section and the binary value processing section on a paper sheet.

### CROSS-REFERENCE TO RELATED APPLICATIONS

This application claims the benefit of U.S. Provisional Applications No. 60/972,480 filed Sep. 14, 2007

### TECHNICAL FIELD

The present invention relates to an image forming apparatus such as a digital multi-function device having an Auto Color Select (ACS) function for determining whether an image of a document is color or monochrome.

### BACKGROUND

Generally, in image forming apparatuses such as color digital multi-function devices, it is possible to selectively process a color image and a monochrome image. Many of the image forming apparatuses have a function called an Auto Color Select (ACS) function for automatically determining whether a document is a color image or a monochrome image.

For example, in Japanese Patent Application No. 2004-144616, the image of a document is determined to be a color image or a monochrome image based on RGB signals read by an image reading unit, and a signal process that can be performed for any RGB signals of the color image and the monochrome image is used. Thus, in Japanese Patent Application No. 2004-144616, a configuration for performing image formation of a color image or a monochrome image without performing a pre-scanning process is disclosed.

### SUMMARY

According to an aspect of the invention, there is provided an image forming apparatus including: a scanner that reads an image of a document; a color determining section that determines whether the document read by the scanner is color or monochrome; a memory that stores image data of the document read by the scanner; a multi-value processing section that converts the image data stored in the memory into image data configured by multi-valued pixels when the image of the document is determined to be color by the color determining section; a binary value processing section that converts the image data stored in the memory into monochrome image data configured by binary pixels when the image of the document is determined to be monochrome by the color determining section; and an image forming section that forms the image data processed by one between the multi-value processing section and the binary value processing section on an image forming target medium.

According to another aspect of the invention, there is provided an image forming method including: reading an image of a document; determining whether the read image of the document is color or monochrome; storing image data of the read document in a memory; converting the image data stored in the memory into color image data configured by multi-valued pixels when the image of the document is determined to be color; converting the image data stored in the memory into monochrome image data when the image of the document is determined to be monochrome; and forming one of the color image data or the monochrome image data on an image forming target medium.

According to still another aspect of the invention, there is provided an image forming apparatus including: reading means for reading an image of a document; color determining means for determining whether the document read by the reading means is color or monochrome; memory means for storing image data of the document read by the reading means; multi-value processing means for converting the image data stored in the memory means into image data configured by multi-valued pixels when the image of the document is determined to be color by the color determining means; binary value processing means for converting the image data stored in the memory means into monochrome image data configured by binary pixels when the image of the document is determined to be monochrome by the color determining means; and image forming means for forming the image data processed by one between the multi-value processing means and the binary value processing means on an image forming target medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration example of an image forming apparatus according to a first embodiment of the invention.

FIG. 2 is a block diagram showing a configuration example of a first image processing section.

FIG. 3 is a block diagram showing a configuration example of a second image processing section.

FIG. 4 is a block diagram showing a configuration example of a third image processing section.

FIG. 5 is a block diagram showing a configuration example of a fourth image processing section.

FIG. 6 is a diagram for showing a copy process in an ACS mode.

### DETAILED DESCRIPTION

Hereinafter, embodiments of the present invention will be described with reference to the accompanying drawings.

First, a first embodiment of the invention will be described.

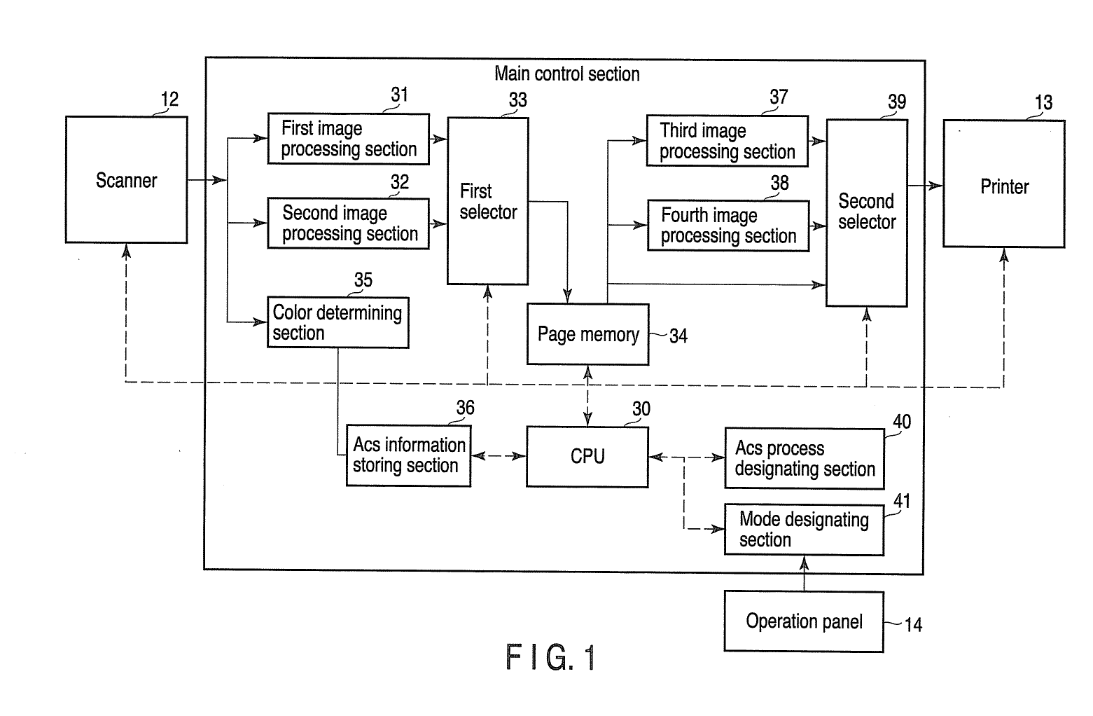

FIG. 1 is a block diagram showing a configuration example of an image forming apparatus 1 according to the first embodiment.

As shown in FIG. 1, the image forming apparatus 1 has a main control section 11, a scanner 12, a printer 13, and an operation panel 14. The image forming apparatus 1, for example, is a digital copier or a digital multi-function device.

The main control section 11 controls the overall operation of the image forming apparatus 1. For example, the main control section 11 controls the operations of the scanner 12 and the printer 13. In addition, the main control section 11 has an image processing function, an image storing function, and the like.

The scanner 12 optically reads an image on a recording medium. Then, the scanner 12 converts the image on the recording medium into image data. The scanner 12 supplies the read image data to the main control section 11. The scanner 12 has CCD line sensors that are used for color reading and an AD conversion unit. In other words, in the scanner 12, the CCD line sensors of each color convert light reflected from the recording medium into analog image signals that represent densities of each color. In addition, the AD conversion unit converts the analog image signals read by the CCD line sensors into digital image signals.

The printer 13 forms the image data supplied from the main control section 11 on an image forming target medium. As the printer 13, a printer using any image forming method may be used. For example, the printer 13 may be a laser printer or an ink jet printer.

The operation panel 14 has a display unit and operation keys. For example, the operation panel 14 has a liquid crystal display device in which a touch panel is built and a hard key such as a numeric keypad.

The main control section 11 has a CPU 30, a first image processing section 31, a second image processing section 32, a first selector 33, a page memory 34, a color determining section 35, an ACS (Auto Color Select) information storing section 36, a third image processing section (multi-value processing section) 37, a fourth image processing section (binary value processing section) 38, a second selector 39, an ACS process designating section 40, and a mode designating section 41.

The CPU 30 is responsible for the overall operation of the image forming apparatus. The CPU 30 implements various functions by performing programs that are stored in a memory not shown in the figure. The CPU 30 serves as first, second, and third control sections. For example, the CPU 30 implements a process for copy control by controlling the scanner 12 and the printer 13 in accordance with a copy control program.

The first image processing section 31 and the second image processing section 32 perform an image process for the image data read by the scanner 12. The first image processing section 31 or the second image processing section 32 stores the image data for which the image process is performed in the page memory 34. The first image processing section 31 performs an image process for image data (a color image or a multi-valued monochrome image) of a multi-valued system. On the other hand, the second image processing section 32 performs an image process for image data (a binary monochrome image) of a binary system.

The first selector 33 selects one between the first image processing section 31 and the second image processing section 32. In particular, the first selector 33 selects one between the first image processing section 31 and the second image processing section 32 in accordance with a direction from the CPU 30. For example, for an operation mode (hereinafter, also referred to as a color designating mode) for designating color scan or color print of a document image, the CPU 30 directs the first selector 33 to select the first image processing section. On the other hand, for an operation mode (hereinafter, also referred to as a monochrome designating mode) for designating monochrome scan or monochrome print of a document image, the CPU 30 directs the first selector 33 to select the second image processing section. In addition, for an operation mode (hereinafter, also referred to as an ACS mode) for determining whether a document is color or monochrome by using the color determining section 35, the CPU 30 directs the first selector 33 to select the first image processing section.

The page memory 34 is a memory used for storing image data to be processed. The page memory 34 is controlled by a page memory control section not shown in the figure. The page memory 34 stores image data of at least one page. The page memory, for example, stores color image data in a compressed state (encoded data).

The color determining section 35 determines whether each pixel constituting the image data is color or monochrome. In particular, the color determining section 35 determines whether each color pixel constituting color image data read by the scanner 12 is color. Described in more detail, the color determining section 35 determines whether each pixel is color or monochrome based on a color difference of the color pixel. For example, when each color pixel is represented by values of R, G, and B, the color determining section 35 determines the pixel color or monochrome by comparing a color difference between an R value and a G value, a G value and a B value, or a B value and an R value with a threshold value. A monochrome pixel has a small density difference (that is, a color difference) of the colors. In other words, a pixel having a color difference smaller than the threshold value is determined as a monochrome (achromatic color) pixel. On the other hand, a pixel having a color difference larger than the threshold value is determined as a color (chromatic color) pixel.

The color determining section 35 is configured to store the determination result for each pixel in the ACS information storing section 36. The ACS information storing section 36 stores the determination result of the color determining section 35. The ACS information storing section 36, for example, stores the number of pixels determined as color pixels and the number of pixels determined as monochrome pixels. The CPU 30 is configured to determine whether a document read by the scanner 12 is color or monochrome based on information stored in the ACS information storing section 36. For example, when determining that the number of pixels, which are stored in the ACS information storing section 36, determined as color pixels is equal to or larger than the threshold value, the CPU 30 determines the image as a color image. In the image forming apparatus 1, the ACS function is implemented by the color determining section 35, the ACS information storing section 36, and the CPU 30.

The third image processing section 37 and the fourth image processing section 38 are configured to perform a process for generating image data (image data for print) to be output to the printer 13. The third image processing section 37 or the fourth image processing section 38 performs an image process for the image data stored in the page memory 34 and outputs the resultant image data to the printer 13. The third image processing section 37 performs an image process for image data (a color image or a multi-valued monochrome image) of a multi-valued system. On the other hand, the fourth image processing section 38 performs an image process for image data (a binary monochrome image) of a binary system.

The second selector 39 selects one of a path through the third image processing section 37, a path though the fourth image processing section 38, and a path for skipping processes of the third and fourth image process sections. In other words, the second selector 39 selects one from among the third image processing section 37, the fourth image processing section 38, and skipping the processes performed by the third and fourth image processing sections in accordance with a direction from the CPU 30. For example, for an operation mode (hereinafter, referred to as an ACS mode) for determining whether a document is color or monochrome by using the ACS function, the CPU 30 selects one between the third image processing section and the fourth image processing section in accordance with the determination result acquired by the ACS function and directs the result of the selection to the second selector 39.

For example, when the document is determined to be monochrome by using the ACS function, the CPU 30 directs the second selector 39 to select the fourth image processing section 38. On the other hand, when the document is determined to be color by using the ACS function, the CPU 30 directs the second selector 39 to select the third image processing section 37. In addition, for the color designating mode, the CPU 30 directs the second selector 39 to select the third image processing section 37. On the other hand, for the monochrome designating mode, the CPU 30 directs the second selector 39 to select the path for skipping the processes performed by the third and fourth image processing sections.

In the ACS process designating section 40, information representing a process to be performed based on the determination result of the document in the ACS mode is stored. For example, in the ACS process designating section 40, information representing a process to be performed when the document is determined to be monochrome in the ACS mode is stored. In other words, when the document is determined to be monochrome in the ACS mode, the CPU 30 determines a process path for the image data stored in the page memory 34 based on the information that is stored in the ACS process designating section 40.

The mode designating section 41 is configured to designate one among the color designating mode, the monochrome designating mode, and the ACS designating mode. For example, the mode can be designated by an operator by using the operation panel 14. In a general operation form, the mode is set as a default setting. When a mode other than the default setting is to be set, the operator inputs information for designating a desired mode by using the operation panel 14. When the information for designating a mode is input to the operation panel 14, the mode designating section 41 updates the mode setting to be the mode that is input to the operation panel 14.

Next, the image processing sections will be described.

First, the first image processing section 31 will be described.

As described above, the first image processing section 31 processes an image (multi-valued image) configured by multi-valued pixels that are read by the scanner 12. The first image processing section 31 performs an image process for the multi-valued image data that is read by the scanner 12 and then, stores the resultant image data in the page memory 34. The first image processing section 31 mainly performs a compression process for the multi-valued image data that is read by the scanner 12.

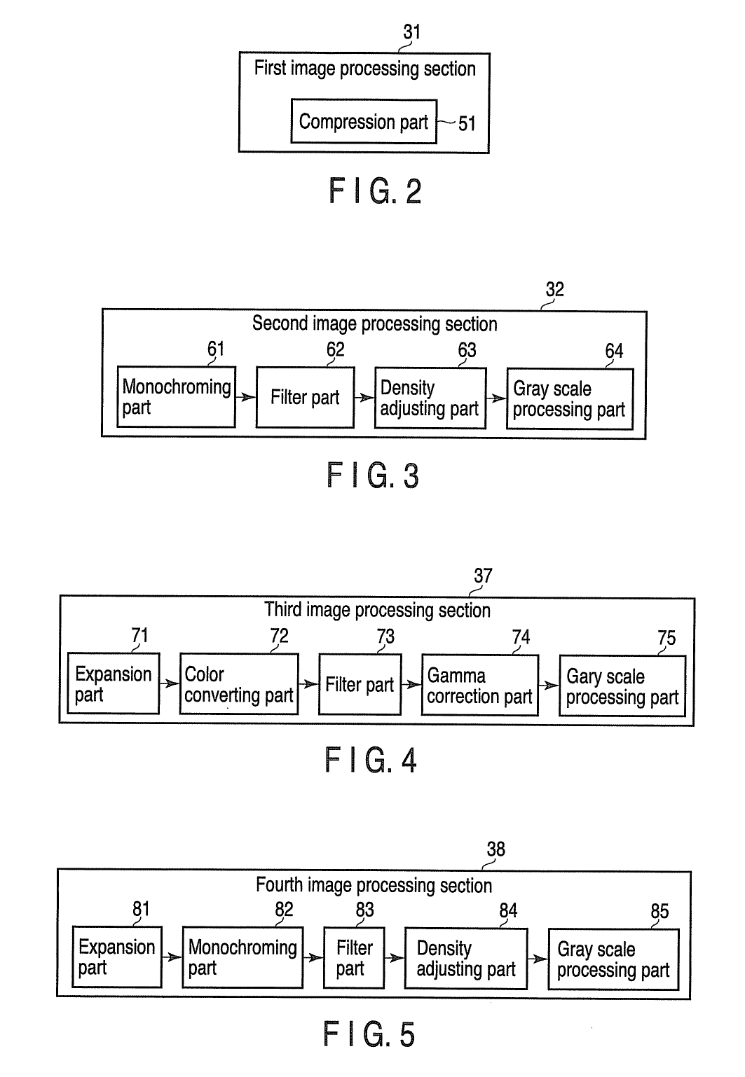

FIG. 2 is a block diagram showing a configuration example of the first image processing section 31.

In the configuration example shown in FIG. 2, the first image processing section 31 has a compression part 51. The compression part 51 compresses the image data configured by color multi-valued pixels read by the scanner 12. Here, it is assumed that the scanner 12 reads a color image that is configured by color pixels represented by three colors of R (red), G (green), and B (blue). Accordingly, the compression part 51 stores the color image data configured by color pixels that are represented by values of R, G, and B in a compressed state in the page memory 34.

In the first image processing section 31, a color converting part and a filter part may be provided in a previous stage of the compression part 51. In such a case, the color converting part and the filter part having the same functions as those of a color converting part 72 and a filter part 73 to be described later may be used. In this embodiment, the first image processing section 31 is described to have the compression part 51 that compresses the multi-valued color image data read by the scanner to be stored in the page memory 34.

Next, the second image processing section 32 will be described.

As described above, the second image processing section 32 converts the image (multi-valued image) configured by multi-valued pixels that are read by the scanner 12 into image data configured by binary pixels. The second image processing section 32 processes the image data read by the scanner 12 as binary monochrome image data and then, stores the resultant image data in the page memory 34. In particular, the second image processing section 32 performs a process such as binarization, correction, or the like as a process for converting the image data read by the scanner 12 into binary monochrome image data.

FIG. 3 is a block diagram showing a configuration example of the second image processing section 32.

In the configuration example shown in FIG. 3, the second image processing section 32 has a monochroming part 61, a filter part 62, a density adjusting part 63, and a gray scale processing part 64.

The monochroming part 61 converts the multi-valued color image data read by the scanner 12 into a monochrome image signal. However, when the scanner 12 has a 4-line CCD line sensor that includes a sensor of K (black) in addition to the sensors of R (red), G (green), and B (blue), a monochroming process is not needed. In such a case, the second image processing section 32 sets the reading result of the CCD line sensor of K (black) as an input image signal. In this embodiment, the second image processing section 32 is assumed to perform a binary image process. In other words, the monochroming part 61 is assumed to convert the color image data configured by the multi-valued color pixels read by the scanner 12 into monochrome image data configured by binary pixels.

The filter part 62 performs a filtering process for the monochromed image data. The filter part 62, as the filtering process, for example, performs a process such as a halftone smoothing process or a text highlighting process. The density adjusting part 63 adjusts the density of the monochrome image data for which the filtering process is performed. The density adjusting part 63, as the density adjusting process, for example, performs a gamma correction process corresponding to the gray scale characteristics of the printer 13 or the like. The gray scale processing part 64 performs a gray scaling process for the monochrome image data of which density is adjusted. The gray scale processing part 64, for example, performs a screen process such as an error diffusion process. The gray scale processing part 64 accumulates the monochrome image data for which the gray scaling process is performed in the page memory 34.

Next, the third image processing section 37 will be described.

As described above, the third image processing section 37 performs a process for the image data configured by multi-valued pixels which is output to the printer 13. The third image processing section 37 converts the multi-valued image data stored in the page memory 34 into multi-valued image data that is used for a printing process. After performing the image process for the image data read from the page memory 34, the third image processing section 37 outputs the resultant image data to the printer 13.

FIG. 4 is a block diagram showing a configuration example of the third image processing section 37.

In the configuration example shown in FIG. 4, the third image processing section 37 has an expansion part 71, a color converting part 72, a filter part 73, a gamma correction part 74, and a gray scale processing part 75.

The expansion part 71 expands the encoded data (compressed image data) stored in the page memory 34. In other words, the expansion part 71 converts the encoded data stored in the page memory 34 into uncompressed multi-valued image data.

The color converting part 72 converts the image data into a color space adjusted to color materials to be output by the printer. As an example, it is assumed that the printer 13 forms an image by using four coloring materials of C (cyan), M (magenta), Y (yellow), and K (black). When the image data expanded by the expansion part 71 is a color image formed of three colors of R (red), G (green), and B (blue), the color converting part 72 converts the image data into image data formed of C, M, Y, and K.

Generally, while there are many scanners 12 that read a document image as color image data formed of R, G, and B signals, there are many printers 13 that print color image data formed of C, M, Y, and K signals. Thus, there are many color converting sections 72 that convert the color image data of R, G, and B into the image data of C, M, Y, and K.

In addition, the color converting part 72 performs a process for converting the color image data into multi-valued monochrome image data. In other words, when multi-valued monochrome image data is generated, the color converting part 72 converts each color pixel formed of values of three colors of R, G, and B, which configures the color image data, into a multi-valued monochrome pixel.

The filter part 73 performs a filtering process for the color-converted image data. The filter part 73, as the filtering process, for example, performs a process such as a halftone smoothing process or a text highlighting process. The gamma correction part 74 performs gamma correction for the image data. The gamma correction is a process for correcting the gray scale characteristics of the printer 13. The gray scale processing part 75 performs a screen process for the image data that is gamma-corrected by the gamma correction part 74. The gray scale processing part 75 outputs the screen-processed image data to the printer 13 as image data used for a printing process.

Next, the fourth image processing section 38 will be described.

As described above, the fourth image processing section 38 generates image data configured by binary monochrome pixels which is output to the printer 13. The fourth image processing section 38 converts the multi-valued color image data stored in the page memory 34 into binary monochrome image data that is used for a printing process. After performing the image process for the image data read from the page memory 34, the fourth image processing section 38 outputs the resultant image data to the printer 13.

FIG. 5 is a block diagram showing a configuration example of the fourth image processing section 38.

In the configuration example shown in FIG. 5, the fourth image processing section 38 has an expansion part 81, a monochroming part 82, a filter part 83, a density adjusting part 84, and a gray scale processing part 85.

The expansion part 81 expands the encoded data (compressed image data) stored in the page memory 34. The first image processing section 31 compresses the multi-valued color image data read by the scanner 12 and stores the compressed image data in the page memory 34. Thus, the expansion part 81 restores the multi-valued color image data read by the scanner 12 by expanding the image data stored in the page memory 34. The monochroming part 82, the filter part 83, the density adjusting part 84, and the gray scale processing part 85 respectively have equivalent functions of the monochroming part 61, the filter part 62, the density adjusting part 63, and the gray scale processing part 64 of the second image processing section 32.

In other words, the monochroming part 82 converts the multi-valued image data (image data equivalent to the image data read by the scanner) that is expanded by the expansion part 81 into monochrome image data configured by binary pixels. Then, the filter part 83 performs a filtering process for the monochromed binary image data. The density adjusting part 84 performs a density adjusting process such as a gamma correction process for the binary monochrome image data for which the filtering process is performed. Then, the gray scale processing part 85 performs a gray scaling process for the monochrome image data of which density is adjusted. Thereafter, the gray scale processing part 85 outputs the binary monochrome image data for which the gray scaling process is performed to the printer 13 as the image data that is used for a printing process.

Next, selection of the first to fourth image processing sections will be described.

Here, it is assumed that the operation mode of the image forming apparatus 1 is one of the color designating mode, the monochrome designating mode, and the ACS mode. The operation mode is designated by an operator by using the operation panel 14. The CPU 30 sets an image process to be performed in a stage before the page memory 34 and an image process to be performed in a stage after the page memory 34 in accordance with the operation mode.

The color designating mode is an operation mode for designating color scan or color print of a document image. When the color designating mode is designated by the operation panel 14, the mode designating section 41 notifies the CPU 30 of a color image process. The CPU 30 that is notified of the color designating mode sets each process block so as to perform a color image process.

For example, for the color designating mode, the CPU 30 selects the first image processing section 31 by using the first selector 33 as an image process performed in the stage before the page memory. In addition, for the color designating mode, the CPU 30 selects the third image processing section 37 by using the second selector 39 as an image process performed in the stage after the page memory 34.

Accordingly, when start of copy in the color designating mode is directed, the scanner 12 reads a document image as multi-valued color image data. Then, the scanner 12 supplies the read image data to the first image processing section 31. The first image processing section 31 performs a compression process and the like for the multi-valued color image data input from the scanner 12. Then, the first image processing section 31 stores the compressed image data (encoded data) in the page memory 34. Thereafter, the third image processing section 37 restores the multi-valued color image data by expanding the data stored in the page memory 34. When the multi-valued color image data is restored, the third image processing section 37 converts the restored image data into color image data that is used for a printing process. Then, the third image processing section 37 supplies the generated color image data that is used for a printing process to the printer 13. Thereafter, the printer 13 forms the color image data supplied from the third image processing section 37 on a paper sheet as an image.

The monochrome designating mode is an operation mode for designating monochrome scan or monochrome print of a document image. When the monochrome designating mode is designated by the operation panel 14, the mode designating section 41 notifies the CPU 30 of a monochrome image process. The CPU 30 that is notified of the monochrome designating mode sets each process block so as to perform the monochrome image process.

As the monochrome image process, there are a binary monochrome image process and a multi-valued monochrome image process. One of the binary monochrome image process and the multi-valued monochrome image process is selected in accordance with a document mode. The document mode is a process mode corresponding to the type of a document image. For example, as the document mode, there are “text and photograph”, “text”, and “photograph”. In the monochrome designating mode, the document mode of “text and photograph” or “text” is processed as a binary monochrome image. On the other hand, the document mode of “photograph” is processed as a multi-valued monochrome image. In other words, when the document mode is “text and photograph” or “text” in the monochrome designating mode, the CPU 30 performs a binary monochrome image process. On the other hand, when the document mode is “photograph” in the monochrome designating mode, the CPU 30 performs a multi-valued monochrome image process.

Here, it is assumed that the document mode is designated by a user by using the operation panel 14. However, the document mode may be configured to be designated by determining an area of a text image and an area of a photograph image by performing a process for identifying an image area of a read image of the document.

When the document mode is “text and photograph” or “text” in the monochrome designating mode, the CPU 30 selects the second image processing section 32 by using the first selector 33, as the image process in the stage before the page memory. In addition, when the document mode is “text and photograph” or “text” in the monochrome designating mode, the CPU 30 selects a path for skipping the image processes that are performed by the third and fourth image processing sections by using the second selector 39, as the image process in the stage after the page memory 34.

When the document mode is “text and photograph” or “text” in the monochrome designating mode, the scanner 12 supplies the image data that is read in accordance with the direction for starting copy to the second image processing section 32. Then, the second image processing section 32 converts the image data input from the scanner 12 into binary monochrome image data. In addition, the second image processing section 32 stores the binary monochrome image data in the page memory 34. Then, the second selector 39 outputs the binary monochrome image data accumulated in the page memory 34 to the printer 13. The printer 13 forms the supplied binary monochrome image data on a paper sheet as an image.

When the document mode is “photograph” in the monochrome designating mode, the CPU 30 selects the first image processing section 31 by using the first selector 33, as the image process in the stage before the page memory. In addition, when the document mode is “photograph” in the monochrome designating mode, the CPU 30 selects the third image processing section 37 by using the second selector 39, as the image process in the stage after the page memory 34. In the color converting part of the third image processing section 37, a monochroming process for converting color pixels into multi-valued monochrome pixels is performed.

When the document mode is “photograph” in the monochrome designating mode, the scanner 12 reads an image of the document as multi-valued color image data in accordance with a direction for starting copy. The scanner 12 supplies the read image data to the first image processing section 31. Then, the first image processing section 31 compresses the image data input from the scanner 12 and accumulates the compressed image data in the page memory 34. Then, the third image processing section 37 restores the multi-valued color image data by expanding the data stored in the page memory 34. When the multi-valued color image data is restored, the third image processing section 37 converts the restored image data into multi-valued monochrome image data that is used for a printing process. In addition, the third image processing section 37 supplies the generated multi-valued monochrome image data that is used for a printing process to the printer 13. Thereafter, the printer 13 forms the multi-valued monochrome image data that is supplied from the third image processing section 37 on a paper sheet as an image.

The ACS mode is an operation mode in which whether a document image is color or monochrome is determined based on the result of determination using the ACS function. When the ACS mode is designated by the operation panel 14, the mode designating section 41 notifies the CPU 30 of an image process corresponding to the result of determination using the ACS function. The CPU 30 that is notified of the ACS mode sets each process block in accordance with the result of determination using the ACS function.

In the image forming apparatus 1, color determination using the ACS function is performed around the same time when the image is read by the scanner 12. In other words, the CPU 30 cannot determine the image process performed in the stage before the page memory 34 based on the result of determination using the ACS function. Accordingly, in the ACS mode, the CPU 30 selects the first image processing section 31 as the image process performed in the stage before the page memory 34. The reason for this is that any process for an image such as a color image or a monochrome image can be performed in the process performed in the stage after the page memory 34 when the first image processing section 31 is used.

In other words, in the ACS mode, the image data read by the scanner 12 is supplied to the first image processing section 31 and the color determining section 35. The first image processing section 31 compresses the image data read by the scanner 12 and accumulates the compressed image data in the page memory 34 as encoded data. Around the same time, the color determining section determines whether each pixel as an input signal from the scanner 12 is color or monochrome.

The color determining section stores the result of determination that represents whether each pixel is color or monochrome in the ACS information storing section 36. In the ACS information storing section 36, for example, as information needed for determining whether a document is color or monochrome, the number of pixels (chromatic color pixels) determined to be color is accumulated. The CPU 30 determines whether the whole document is color or monochrome based on the information stored in the ACS information storing section 36. For example, when the number of chromatic color pixels is equal to or larger than a predetermined threshold value, the CPU 30 determines the document as a color document. On the other hand, when the number of the chromatic color pixels is smaller than the predetermined threshold value, the CPU 30 determines the document as a monochrome document. The CPU 30 determines whether the image process in the stage after the page memory is performed as a multi-valued process or a binary process based on the result of determination, that is, the result of determination using the ACS function.

For example, when determining that the document is a color document by using the ACS function, the CPU 30 selects the third image processing section 37 by using the second selector 39. In such a case, the third image processing section 37 expands the encoded data stored in the page memory 34 and performs an image process for the expanded image data. The image data processed by the third image processing section 37 is output to the printer 13 as color image data used for a printing process. The printer 13 forms the color image data supplied from the third image processing section 37 on a paper sheet as a color image.

On the other hand, when determining that the document is a monochrome document by using the ACS function, the CPU 30 selects the fourth image processing section 38 by using the second selector 39. However, when a document mode for a multi-valued process is selected, the CPU 30 selects the third image processing section 37 by using the second selector 39. When determining that the document is a monochrome document by using the ACS function, the CPU 30 determines whether the document mode is for a multi-valued process or a binary process, additionally. When the document mode is determined to be for a binary process, the CPU 30 selects the fourth image processing section 38 by using the second selector 39. In such a case, the fourth image processing section 38 expands the encoded data stored in the page memory 34 and performs an image process that is equivalent to that of the second image processing section 32 for the expanded image data. Accordingly, the image data processed by the fourth image processing section 38 becomes equivalent to the image data (that is, the image data in the monochrome designating mode) processed by the second image processing section 32. The binary monochrome image data that is generated by the fourth image processing section 38 is output to the printer 13 as monochrome image data used for a printing process. The printer 13 forms the binary monochrome image data supplied from the fourth image processing section 38 on a paper sheet as a binary monochrome image.

On the other hand, when the document mode is determined to be for a multi-valued process, the CPU 30 selects the third image processing section 37 by using the second selector 39. In such a case, the third image processing section 37 expands the encoded data stored in the page memory 34 and performs an image process for the expanded image data. However, the third image processing section 37 converts color pixels into multi-valued monochrome pixels by using the color converting section for converting the image data into multi-valued monochrome image data. The image data processed by the third image processing section 37 is output to the printer 13 as multi-valued monochrome image data used for a printing process. The printer 13 forms the multi-valued monochrome image data supplied from the third image processing section 37 on a paper sheet as a multi-valued monochrome image.

In the above-described image forming apparatus, even when a document is determined to be monochrome by using the ACS function that is performed in parallel with a process for reading a document image by using the scanner 12, an image process that can acquire an image having the same image quality as that in the monochrome designating mode is performed for the image read by the scanner 12. As a result, the image forming apparatus 1 can acquire an image of an equivalent image quality when the ACS function is used or the monochrome designating mode is designated.

Next, the flow of a copy process of the image forming apparatus 1 in the ACS mode will be schematically described.

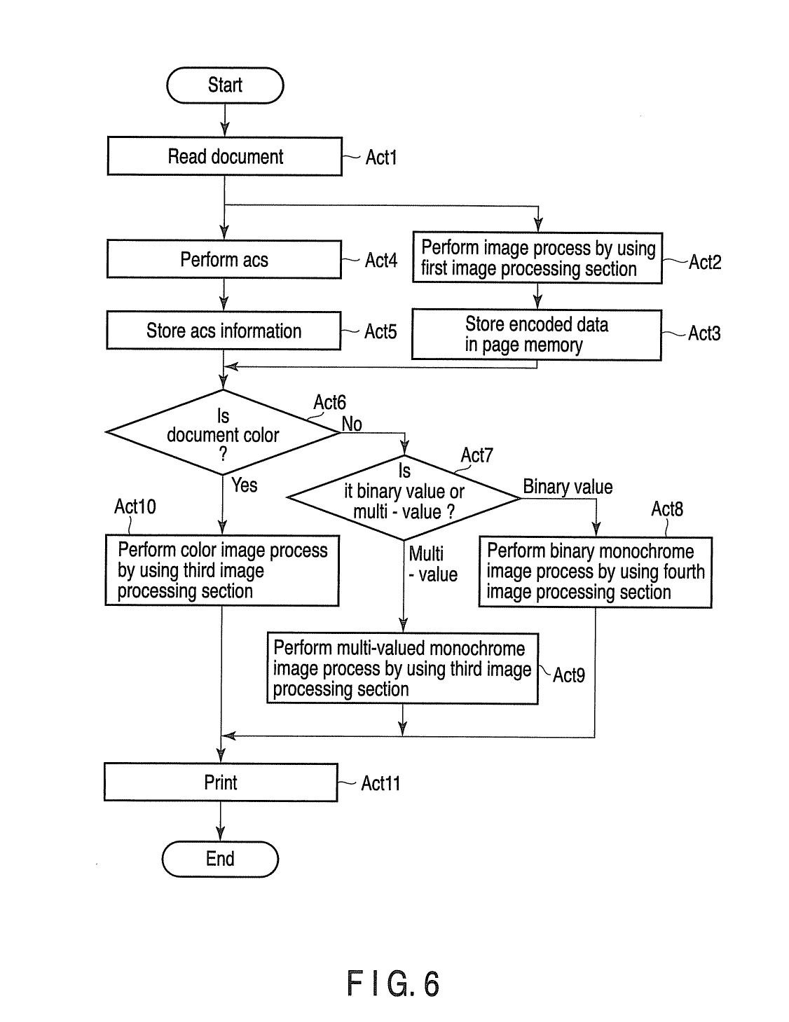

FIG. 6 is a diagram showing a copy process in the ACS mode.

In the ACS mode, when the copy process is directed, the CPU 30 directs the scanner 12 to start reading a document and directs the first selector 33 to select the first image processing section 31. Then, the scanner 12 starts reading the image of the document in accordance with the direction for starting reading the document which is transferred from the CPU 30. In addition, the first selector 33 selects the first image processing section 31. Then, the scanner 12 reads the image of the document as color image data configured by multi-valued color pixels (Act 1). Thereafter, the scanner 12 supplies the read image data to the first image processing section 31 and the color determining section 35. Then, the first image processing section 31 compresses the image data supplied from the scanner 12 (Act 2). In addition, the first image processing section 31 accumulates encoded data as compressed image data in the page memory 34 (Act 3).

The color determining section 35 sequentially determines whether each pixel of the image data supplied from the scanner 12 is a color pixel or a monochrome pixel (Act 4). Then, the color determining section 35 stores the number of pixels determined to be color pixels in the ACS information storing section 36 (Act 5). When the color determining process for an image of one page is completed, the CPU 30 determines whether the document is color or monochrome based on the information stored in the ACS information storing section 36 (Act 6). For example, when the number of the color pixels stored in the ACS information storing section 36 is equal to or larger than a threshold value, the CPU 30 determines the document to be a color image. On the other hand, when the number of the color pixels is smaller than the threshold value, the CPU 30 determines the document to be a monochrome image.

When the document is determined to be monochrome, the CPU 30 determines whether the document is a monochrome image for a binary process or a monochrome image for a multi-valued process, additionally (Act 7). For example, when the document mode is “photograph”, the CPU 30 selects a multi-value monochrome image process. On the other hand, when the document mode is “text and photograph” or “text”, the CPU 30 selects a binary monochrome image process.

When the binary process of monochrome is selected (Act 7, a binary value), the CPU 30 selects the fourth image processing section 38 by using the second selector 39, as the image process in the stage after the page memory 34. Then, the fourth image processing section 38 performs image processes such as a process for expanding encoded data stored in the page memory 34 and a binary monochroming process for the expanded image data (Act 8). The printer 13 prints an image based on the binary monochrome image data processed by the fourth image processing section 38 on a copy sheet (Act 11).

On the other hand, when the multi-valued process of monochrome is selected (Act 7, a multi-value), the CPU 30 selects the third image processing section 37 by using the second selector 39, as the image process in the stage after the page memory 34. Then, the third image processing section 37 performs image processes such as a process for expanding encoded data stored in the page memory 34 and a multi-value monochroming process for the expanded image data (Act 9). The printer 13 prints an image based on the multi-valued monochrome image data processed by the third image processing section 37 on a copy sheet (Act 11).

When the document is determined to be color (Act 6, YES), the CPU 30 selects the third image processing section 37 by using the second selector 39, as the image process in the stage after the page memory 34. Then, the third image processing section 37 performs color image processes such as a process for expanding the encoded data stored in the page memory 34 and a process for color changing for the expanded image data (Act 10). The printer 13 prints an image based on the color image data processed by the third image processing section 37 on a copy sheet (Act 11).

As described above, in this embodiment, the image of a document is read by the scanner. Then, the image of the document read by the scanner is stored in the memory, and the color determining section determines whether the document read by the scanner is color or monochrome. When the color determining section determines the image to be color, the image data stored in the memory is converted into color image data configured by multi-valued pixels by using the multi-value processing section. On the other hand, when the color determining section determines the image to be monochrome, the image data stored in the memory is converted into monochrome image data configured by binary pixels by the binary value processing section. Then, the printer forms image data processed by one between the multi-value processing section and the binary value processing section on a paper sheet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a scanner that reads an image of a document;
a color determining section that determines whether the document read by the scanner is color or monochrome;
a memory that stores image data of the document read by the scanner;
a multi-value processing section that converts the image data stored in the memory into image data configured by multi-valued pixels when the image of the document is determined to be color by the color determining section;
a binary value processing section that converts the image data stored in the memory into monochrome image data configured by binary pixels when the image of the document is determined to be monochrome by the color determining section; and
an image forming section that forms the image data processed by one between the multi-value processing section and the binary value processing section on an image forming target medium.

2. The apparatus according to claim 1, further comprising a selector that selects the binary value processing section when the image of the document is determined to be monochrome by the color determining section and selects the multi-value processing section when the image of the document is determined to be color by the color determining section.

3. The apparatus according to claim 1, further comprising an operation unit that designates a document mode,
wherein the binary value processing section converts the image data stored in the memory into monochrome image data configured by binary pixels when the image of the document is determined to be monochrome by the color determining section and the document mode is a binary monochrome image, and
wherein the multi-value processing section converts the image data stored in the memory into monochrome image data configured by multi-valued monochrome pixels when the image of the document is determined to be monochrome by the color determining section and the document mode is a multi-valued monochrome image.

4. The apparatus according to claim 1,
wherein the color determining section determines whether each pixel configuring the image data read by the scanner is a color pixel and determines the document to be color when the number of pixels determined to be color pixels by the determination is equal to or larger than a threshold value and determines the document to be monochrome when the number of the pixels determined to be color pixels is smaller than the threshold value.

5. The apparatus according to claim 1, further comprising:
a first image processing section that compresses the image data of the document read by the scanner and stores the compressed image data in the memory;
a second image processing section that converts the image data read by the scanner into a binary monochrome image;
an operation unit that designates one of a color designating mode, a monochrome designating mode, and selecting mode as an operation mode;
a first control section that processes the image data of the document read by the scanner by using the first image processing section and processes the image data processed by the first image processing section by using the multi-value processing section, in the color designating mode;
a second control section that processes the image data of the document read by the scanner by using the second image processing section and supplies the image data processed by the second image processing section to the image forming section, in the monochrome designating mode; and
a third control section that processes the image data read by the scanner by using the first image processing section, processes the image of the document, which is determined to be monochrome by the color determining section, of the image data processed by the first image processing section by using the binary value processing section, and processes the image of the document determined to be color by the color determining section by using the multi-value processing section, in the color designating mode.

6. The apparatus according to claim 5, wherein the process performed by the second image processing section for converting the image data of the document read by the scanner into the binary monochrome image and the process performed by the binary value processing section for converting the image data read from the memory into the binary monochrome image are equivalent.

7. The apparatus according to claim 5,
wherein the operation unit designates the document mode additionally, and
wherein, when the image of the document is determined to be monochrome by the color determining section, the third control section processes the image data of the document processed by the first image processing section by using the binary value processing section when the document mode is a binary monochrome image and processes the image data of the document processed by the first image processing section by using the multi-value processing section when the document mode is a multi-valued monochrome image.

8. An image forming method comprising:
reading an image of a document;
determining whether the read image of the document is color or monochrome;
storing image data of the read document in a memory;
converting the image data stored in the memory into color image data configured by multi-valued pixels when the image of the document is determined to be color;
converting the image data stored in the memory into monochrome image data when the image of the document is determined to be monochrome; and
forming one of the color image data or the monochrome image data on an image forming target medium.

9. The method according to claim 8, further comprising:
selecting a path for converting the image data stored in the memory into monochrome image data when the image of the document is determined to be monochrome; and
selecting a path for converting the image data stored in the memory into color image data when the image of the document is determined to be color.

10. The method according to claim 8, further comprising:
designating a document mode;
converting the image data stored in the memory into monochrome image data configured by binary pixels if the document mode is a binary monochrome image when the image of the document is determined to be monochrome; and
converting the image data stored in the memory into monochrome image data configured by multi-valued monochrome pixels if the document mode is a multi-valued monochrome image when the image of the document is determined to be monochrome.

11. The method according to claim 8, wherein the determining whether the read image is color or monochrome includes determining whether each pixel configuring the read image data is a color pixel, determining the document to be color when the number of pixels determined to be color pixels is equal to or larger than a threshold value, and determining the document to be monochrome when the number of the pixels is smaller than the threshold value.

12. The method according to claim 8, further comprising:
compressing the image data of the read document and storing the compressed image data in the memory;
converting the image data of the read document into a binary monochrome image;
designating one of a color designating mode, a monochrome designating mode, and a color selecting mode as an operation mode;
compressing the image data of the read document, storing the compressed image data in the memory, and processing the image data stored in the memory by using the multi-value processing section when the operation mode is the color designating mode;
converting the image data of the read document into a binary monochrome image and forming the converted binary monochrome image on an image forming target medium when the operation mode is the monochrome designating mode; and
determining whether the read document is color or monochrome, compressing the image data of the read document, storing the compressed image data in the memory, converting the image of the document, which is determined to be monochrome, of the image data stored in the memory into monochrome image data, and converting an image of the document, which is determined to be color, of the image data stored in the memory into color image data, when the operation mode is the color selecting mode.

13. The method according to claim 12, wherein the process for converting the image data of the read document into the binary monochrome image and the process for converting the image data read from the memory into the binary monochrome image are equivalent.

14. The method according to claim 12, further comprising:
designating a document mode; and
converting the image data of the document stored in the memory into binary monochrome image data if the document mode is a binary monochrome image and converting the image data of the document stored in the memory into multi-valued monochrome image data if the document mode is the multi-valued monochrome image, when the read document is determined to be monochrome.

15. An image forming apparatus comprising:
reading means for reading an image of a document;
color determining means for determining whether the document read by the reading means is color or monochrome;
memory means for storing image data of the document read by the reading means;
multi-value processing means for converting the image data stored in the memory means into image data configured by multi-valued pixels when the image of the document is determined to be color by the color determining means;
binary value processing means for converting the image data stored in the memory means into monochrome image data configured by binary pixels when the image of the document is determined to be monochrome by the color determining means; and
image forming means for forming the image data processed by one between the multi-value processing means and the binary value processing means on an image forming target medium.

16. The apparatus according to claim 15, further comprising selecting means for selecting the binary value processing means when the image of the document is determined to be monochrome by the color determining means and selecting the multi-value processing means when the image of the document is determined to be color by the color determining means.

17. The apparatus according to claim 15, further comprising operating means for designating a document mode,
wherein the binary value processing means converts the image data stored in the memory means into monochrome image data configured by binary pixels when the image of the document is determined to be monochrome by the color determining means and the document mode is a binary monochrome image, and
wherein the multi-value processing means converts the image data stored in the memory means into monochrome image data configured by multi-valued monochrome pixels when the image of the document is determined to be monochrome by the color determining means and the document mode is a multi-valued monochrome image.

18. The apparatus according to claim 15, wherein the color determining means determines whether each pixel configuring the image data read by the reading means is a color pixel and determines the document to be color when the number of pixels determined to be color pixels by the determination is equal to or larger than a threshold value and determines the document to be monochrome when the number of the pixels determined to be color pixels is smaller than the threshold value.

19. The apparatus according to claim 15, further comprising:
first image processing means for compressing the image data of the document read by the reading means and storing the compressed image data in the memory means;
second image processing means for converting the image data of the document read by the reading means into a binary monochrome image;
operating means for designating one of a color designating mode, a monochrome designating mode, and a color selecting mode as an operation mode;
first control means for processing the image data of the document read by the reading means by using the first image processing means and processing the image data processed by the first image processing means by using the multi-value processing means, in the color designating mode;
second control means for processing the image data of the document read by the reading means by using the second image processing means and supplying the image data processed by the second image processing means to the image forming means, in the monochrome designating mode; and
third control means for processing the image data read by the reading means by using the first image processing means, processing the image of the document, which is determined to be monochrome by the color determining means, of the image data processed by the first image processing means by using the binary value processing means, and processing the image of the document determined to be color by the color determining means by using the multi-value processing means, in the color selecting mode.

20. The apparatus according to claim 19, wherein the process performed by the second image processing means for converting the image data of the document read by the reading means into the binary monochrome image and the process performed by the binary value processing means for converting the image data read from the memory means into the binary monochrome image are equivalent.

21. The apparatus according to claim 19,
wherein the operating means designates the document mode additionally, and
wherein, when the image of the document is determined to be monochrome by the color determining means, the third control means processes the image data of the document processed by the first image processing means by using the binary value processing means when the document mode is a binary monochrome image and processes the image data of the document processed by the first image processing means by using the multi-value processing means when the document mode is a multi-valued monochrome image.
